(19) United States
(12) Patent Application Publication
(10) Pub. No.: US 2016/0352409 A1
(43) Pub. Date: Dec. 1, 2016

(54) Method and Wireless Device for Antenna Selection

(71) Applicant: MEDIATEK INC., Hsin-Chu (TW)

(72) Inventors: Wei-Ping Chuang, Kaohsiung City (TW); Hai-Pin Liang, Taipei City (TW); Tsung-Hsuan Wu, Changhua County (TW)

(21) Appl. No.: 15/235,089

(22) Filed: Aug. 11, 2016

Related U.S. Application Data
(63) Continuation-in-part of application No. 13/936,206, filed on Jul. 7, 2013.
(60) Provisional application No. 61/668,610, filed on Jul. 6, 2012.

(51) Int. Cl. H04B 7/08; H04B 7/04

(52) U.S. Cl. CPC H04B 7/0805; H04B 7/0404

(57) ABSTRACT

A method for a wireless device is disclosed. The wireless device includes a plurality of antennas. The method includes the steps of transmitting a first packet to a first client and receiving a response from the first client. The wireless device then determines a first set of the plurality of antennas for the first client according to a statistic obtained from the response. Then, the wireless device transmits a packet to a first client using the first set of the plurality of antennas.

### CROSS REFERENCE TO RELATED APPLICATION

This application is a continuation-in-part application and claims the benefit of U.S. non-provisional application Ser. No. 13/936,206, which was filed on Jul. 7, 2013 and is incorporated herein by reference. In addition, the U.S. non-provisional application Ser. No. 13/936,206 claims the benefit of U.S. provisional application No. 61/668,610, filed on Jul. 6, 2012.

### BACKGROUND

The present disclosure relates generally to communication, and more specifically to antenna selection during transmission and reception in a wireless communication network.

A wireless communication network may include an access point and many stations. Each station may be located anywhere within the wireless network. An access point usually uses one or more omni antennas to transmit or receive data from all the stations. However, a conventional access point needs extra information provided from the station and has to determine which one or more antennas should be use each time data is determined to transmit to a certain station, which reduces the efficiency of the wireless network.

There is therefore a need in the art for techniques to improve performance of data transmission and reception in a wireless communication network.

### SUMMARY

Therefore, the primary objective of the present invention is to provide a method and a wireless communication device for determining which antenna should be used for transmission and reception. The present invention discloses a method for a wireless device, wherein the wireless device comprises a plurality of antennas. The method comprises transmitting first packet to a first client and receiving a response from the first client. The wireless device then determines a first set of the plurality of antennas for the first client according to a statistic obtained from the response. Then, the wireless device transmits a packet to a first client using the first set of the plurality of antennas.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication device according to an embodiment of the invention.

FIG. 2 illustrates a possible architecture of the wireless device according to an embodiment of the invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in sub-module. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

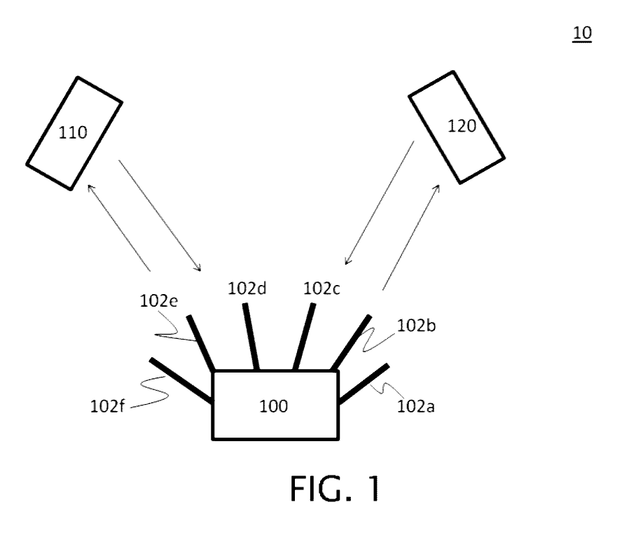

Please refer to FIG. 1, which is a schematic diagram of the wireless communication system 10 according to an embodiment of the invention. The wireless communication system 10 includes a wireless device 100, a first client 110 and a second client 120. The wireless device 100 can be an access point (AP) commonly used in wireless local area network (WLAN) or a station (STA) with a software AP function. The wireless device 100 includes a plurality of antennas 102a-102f. The first client 110 and the second client 120 can be a station (STA) commonly used in WLAN or another AP. Noticeably, the embodiment of the invention demonstrates an example of an AP having six antennas; however those skilled in the art can adaptively modify the number of the antennas for different requirements. In simple, the embodiments of the invention hereinafter will discuss the cases with where the AP has six antennas 102a-102f in the following paragraphs, which is not limiting the scope of the invention. In addition, the antennas 102a-102f may be directional antennas or at least one of the antennas 102a-102f may be an omni-directional antenna.

### 1. Training Process

Please refer to the wireless communication system in FIG. 1. The wireless device 100 first determines how to communicate with the first client 110 and the second client 120. According to an embodiment of the present invention, the wireless device 100 sends a plurality of channel check packets (CCP) to the first client 110. After receiving the CCPs, the first client 110 responds with channel response packets (CRP). Please note that a CCP can be a quality of service (QoS) null type packet, and a CRP can be a normal acknowledgement (ACK) type packet. The wireless device 100 obtains received signal strength indicator (RSSI) and other signal information from the CRPs. According to the RSSI, the wireless device 100 may estimate a possible modulation and coding scheme (MCS) and a payload length of the CCP that can be used for further antenna selection. However, those skilled in the art will appreciate that there are other methods that can be used to estimate the possible MCS for transmission between the wireless device and the first client. And the present invention is not limited to the method mentioned above . Since the wireless device 100 can estimate and decide a MCS and/or payload length according to the ACKs from the first client 110, no extra information is required to be sent from the first client 110 to the wireless device 100. This helps to minimize the training time for the decision of an antenna selection. This process can also be treated as an open loop control process.

According to an embodiment of the present invention, the wireless device 100 may decide an MCS and a payload length when only one spatial stream with 40 MHz bandwidth is used. For example, the wireless device 100 may decide an initial MCS of 2 and a payload length of 400 bytes can be decided if the RSSI is lower than −85dbm. If the RSSI is higher than −85 dbm, an initial MCS of 7 and a payload length of 1000 bytes can be decided, accordingly. In a different example, where two spatial streams with 40 MHz bandwidth are used by the wireless device 100, an initial MCS of 2 and a payload length of 400 bytes can be decided if the RSSI is lower than −85 dbm. If the RSSI is higher than −75dbm, an initial MCS of 15 and a payload length of 2000 bytes can be decided, accordingly. For the RSSI that is between −85dbm and −75dbm, an initial MCS of 7 and a payload length of 1000 bytes can be decided, accordingly. Please note that these examples are only used to explain the spirit of the invention and are not intended to limit the scope of this invention.

According to another embodiment of the present invention, the above process can be performed by hardware. For example, the circuit within the wireless device 100 can collect the statistics and make the decision. Or, according to a further embodiment of the present invention, the circuit within the wireless device 100, hardware, can collect the statistics and then provide it to a software within the wireless device 100 or in another device at a higher level to use the collected statistics as a reference to a selection algorithm.

Afterwards, the wireless device 100 selects one of the antennas, 102e, for example, to send a CCP to associate the first client 110 then waits for the corresponding response. If no response is received, the wireless device 100 will try another MCS, i.e. try MCS auto fallback, until the corresponding CRP is successfully received. Therefore, the total retry count of the CCP from the first client 110 is recorded for the antenna 102e. This procedure can be repeated for all the antennas 102a-102f. Also, this procedure can also be performed for different combinations of the antennas, for example but not limited to, using antennas 102e and 102f as an antenna set, or using antennas 102f, 102c and 102a as another antenna set. The retry counts for each antenna and different combinations/sets are recorded. The wireless device 100 thus may choose a best antenna set, which may be one single antenna or a combination of antennas, for the first client 110. For example, the antenna or the combination of antennas with the least retry count can be chosen. Further, the antenna set for the first client 110 may comprise a plurality of directional antennas or a combination of an omni-directional antenna and a directional antenna.

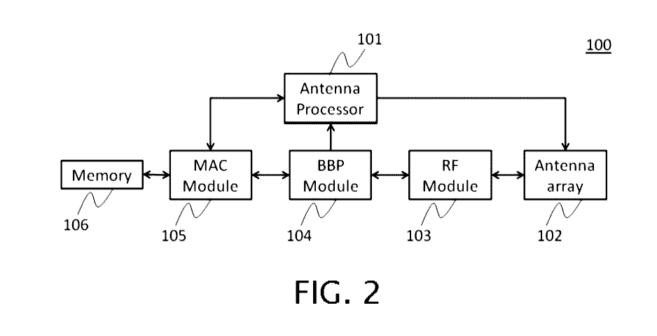

Then, the similar process is performed again for the second client 120. And the retry counts for each antenna and different combinations are recorded. The wireless device 100 thus may choose a best antenna set, which may be one single antenna or a combination of antennas, for the second client 120. The antenna set for the second client 120 may comprise a plurality of directional antennas or a combination of an omni-directional antenna and a directional antenna. The antenna sets for the first client 110 and the second client 120 may overlap and does not have to be absolutely different. These results are then stored in a memory 106 in the wireless device 100, as shown in FIG. 2.

Therefore, according to the present invention, the wireless device 100 can determine a respective antenna or a respective antenna set for transmission/reception with the first client 110 and the second client 120 solely based on the information contained in an ACK that the first client 110 and the second client 120 sent. In other words, the antenna selection method can be performed in an open loop fashion. Therefore, no extra information is required from the first client 110 or the second client 120 to determine the antenna or antenna set used.

### 2. Transmission

Now please refer to FIG. 2, which illustrates an exemplary architecture of the wireless device 100. The wireless device 100 includes an antenna array 102, which includes the antennas 102a-102g, a radio frequency (RF) module 103, a baseband processing module (BBP) 104, a medium access control module (MAC) 105, a memory 106, and an antenna processor 101. The antenna processor 101 can be used to control which antenna or antenna set that should be used for transmission according to the data stored in the memory 106. Please note that the antenna processor 101 can be integrated into the BBP module 104 or the MAC module 105. The illustration is provided as an example and the present invention is therefore not limited to it.

According to an embodiment of the present invention, when the wireless device 100 has a first packet destined to the client 110 and a second packet destined to the client 120, the antenna processor 101 gets information from the MAC module 105 that there's a packet for the first client 110. The antenna processor 110 notifies the antenna array 102 about the antenna or the antenna set that should be used to transmit the first packet to the first client 110. Hence, the antenna array 102 uses the antenna set obtained from the training process to transmit the first packet to the first client 110. The antenna processor 110 may then notifies the antenna array 102 to switch to the antenna set for the second client 120 and therefore the antenna array 102 uses it to transmit the second packet to the second client 120.

By doing so, the wireless device 100 is capable to use the best antenna set for transmission on a per packet base. In addition, the wireless device 100 may also use the best antenna set for receiving the ACK from the first client 110 and the second client 120, respectively, until time out.

### 3. Reception

If the first client 110 has a packet to be transmitted to the wireless device 100, the first client 110 sends a clear-to-send (CTS) or a request-to-send (RTS) packet to notify the wireless devices in the neighborhood. Upon receiving this packet, the antenna processor 101 of the wireless device 100 can instruct the antenna array 102 to switch to the antenna set for the first client 110 to receive the packet from the first client 110. It is because that the channel between the wireless device 100 and the first client 110 is assumed to be steady and therefore the best antenna set for transmission should be the best antenna for reception.

However, if the reception is failed or if the wireless device 100 is intended to listen to other clients, the wireless device 100 may switch to an omni-directional antenna or omni-directional antenna set to extend the coverage to un-associated clients or to a moving client. According to another embodiment of the present invention, the wireless device 100 may also use an Optimal Antenna Set that is optimal for all associated clients. This helps to enhance the receiving capability to all associated clients, because the wireless device 100 is uncertain which associate client will transmit a data packet

To sum up, according to the methods disclosed in the invention, a wireless communication device can determine an antenna set best for transmission and reception, which is efficient and cost-effective.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a wireless device, wherein the wireless device comprises a plurality of antennas, the method comprising, transmitting a first packet to a first client;
receiving a response from the first client;
determining a first set of the plurality of antennas for the first client according to a statistic obtained from the response; and
transmitting a packet to a first client using the first set of the plurality of antennas.

2. The method of claim 1, wherein the first packet is a channel check packet (CCP).

3. The method of claim 1, wherein the response is a channel response packet (CRP).

4. The method of claim 1, wherein the statistic is a received signal strength indicator (RSSI).

5. The method of claim 1, wherein the statistic is a total retry count of the CCP from the first client.

6. The method of claim 1, further comprising,
transmitting second packet to a second client;
receiving a response from the second client;
determining a second set of the plurality of antennas for the second client according to a statistic obtained from the response; and
transmitting a packet to a first client using the first set of the plurality of antennas.

7. The method of claim 1, further comprising,
receiving a packet from the first client using the first set of the plurality of antennas.

8. The method of claim 1, further comprising,
transmitting second packet to a second client;
receiving a response from the second client;
determining a second set of the plurality of antennas for the second client according to a statistic obtained from the response; and
transmitting a packet to a first client using the first set of the plurality of antennas.

9. The method of claim 8, further comprising,
receiving a packet from the second client using the second set of the plurality of antennas.

10. The method of claim 1, wherein at least one of the first set of the plurality of antennas and the second set of the plurality of antennas comprises at a directional antenna.

11. The method of claim 1, wherein at least one of the first set of the plurality of antennas and the second set of the plurality of antennas comprises an omni-directional antenna and a directional antenna.

12. The method of claim 1, further comprising,
switching to an omni-directional antenna of the plurality of antennas; and
receiving a packet from other clients with the omni-directional antenna.

13. The method of claim 1, further comprising,
receiving a request from the first client; and
switching to the first set of the plurality of antennas.

14. The method of claim 1, wherein the step of determining the first set of the plurality of antennas comprises,
transmitting a plurality of null packets through each of the plurality of antennas to the first client;
generating an index according to a plurality of received packets in response to the plurality of null packets transmitted by each antenna; and
determining the first set of the plurality of antennas according to the index.
